(19) United States
(12) Patent Application Publication
(10) Pub. No.: US 2006/0251181 A1
(43) Pub. Date: Nov. 9, 2006

(54) Method and system for signal detection using a reduced transmitter constellation

(75) Inventors: Vummintala Shashidhar, Santa Clara, CA (US); Balaji Sundar Rajan, Santa Clara, CA (US)

Correspondence Address: Beceem Communications Inc., 3930 Freedom Circle, #101, Santa Clara, CA, 95054, US

(73) Assignee: Beceem Communications, Inc.

(21) Appl. No.: 11/372,331

(22) Filed: Mar. 8, 2006

(30) Foreign Application Priority Data
Mar. 22, 2005 (IN) 323/MUM/2005

(51) Int. Cl. H04L 23/02

(52) U.S. Cl. 375/262

(57) ABSTRACT

The present invention relates to a method, typically deployed on receivers deployed, for detecting a transmitted signal from a transmitter constellation by quantizing an altered signal to obtain a reduced constellation from the transmitter constellation (205), and then performing a maximum-likelihood detection scheme on the reduced constellation to obtain the transmitted signal (210). A system (120, 125) to perform the detection is also disclosed.

### RELATED APPLICATION DATA

This application claims priority to and incorporates by reference India application serial number 323/MUM/2005 filed on Mar. 22, 2005, titled ZF restricted ML detection

### FIELD OF INVENTION

The present invention relates generally to network communications, and more specifically to signal detection techniques in multi-path and multi-channel systems.

### BACKGROUND OF THE INVENTION

As wireless modes of communication proliferate, the need to transmit at higher data rates is gaining importance. Several methods such as Orthogonal Frequency Division Multiplexing (OFDM) and Space Division Multiplexing offer greater spectral efficiency and superior tolerance in communication through multi-path channels.. Multi-path and MIMO (multiple-input-multiple-output) modes of communication are the generally preferred modes of communication as they provide better transmission rates, efficiency and accuracy.

The transmitted signal needs to be accurately detected at the receiver antennas and for this purpose, several detection schemes such as Zero-Forcing (ZF) detection, sphere decoding, Maximum Likelihood (ML) detection, and K-best detection are known in the art and can be used. Each of these known schemes, however, have certain disadvantages, for example, in ML detection, the decoding complexity increases exponentially with the size of the transmitter constellation, while providing very good performance in terms of probability of error. For schemes such as ZF detection the decoding complexity increases only linearly with respect to the size of the transmitter constellation whereas the performance greatly depends on the co-relation among the paths of the MIMO channel and therefore is limited in achieving good performance by itself. The sphere detection scheme involves finding a subset of a received constellation to do an ML search and also doing various mathematical computations such as QR factorization on the channel matrix and therefore has increased complexity. The K-best scheme generally cannot guarantee the survival of ML paths with overall possible candidate paths. This is because the path metrics of the search-tree created sometimes cross each other and causes irreducible errors, which degrades the symbol error rate performance, even if the signal-to-noise ratio (SNR) is high.

Thus, there is a need to provide an efficient and low complexity signal detection mechanism with different levels of tradeoff between performance and complexity.

### BRIEF DESCRIPTION OF THE DRAWINGS

The accompanying figures together with the detailed description below are incorporated in and form part of the specification, serve to further illustrate various embodiments and to explain various principles and advantages all in accordance with the present invention, and should not be construed to limit the invention.

FIG. 1 shows an illustrative configuration of a wireless communication system in accordance with an embodiment of the invention.

FIG. 2 illustrates a flow diagram depicting the steps performed during detection pursuant to an embodiment of the invention.

FIG. 3 is a flow diagram depicting the steps of quantizing an altered signal based on a modulation scheme in accordance with an embodiment of the invention.

FIG. 4 shows a first embodiment of a graphical representation of the transmitter signal constellation.

FIG. 5 shows a second embodiment of a graphical representation of the transmitter signal constellation.

### DETAILED DESCRIPTION

While embodiments may be described in many different forms, there are shown in the figures and will herein be described in detail certain specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, common and well-understood elements that are useful or necessary in a commercially feasible embodiment may not be depicted in order to facilitate a less obstructed view of these various embodiments. Also, elements shown in the figures have not necessarily been drawn to scale. For example, the dimensions of some of the elements are exaggerated relative to each other. Further, where considered appropriate, reference numerals have been repeated among the figures to indicate corresponding elements.

As wireless modes of communication proliferate, the need to transmit at higher data rates is gaining importance. Once a signal has been transmitted, several detection techniques may be available at the receiver to identify and detect the transmitted signal. Generally, the transmitted signal is detected from a signal constellation corresponding to the transmitter antennas and based on the modulation scheme employed.

An embodiment of the present invention discloses a method of using a detection method, for instance a ZF detection, an MMSE (Minimum Mean Square Error) detection or a substitute for this method to isolate a single constellation point from the transmitter constellation. Those skilled in the art shall appreciate that such generally known detection schemes that can isolate a single constellation point from the transmitted constellation may be used, and all such detection schemes are within the scope of the present invention. Quantizing the received point in the single constellation space or another point obtained from the received point to some of the signal constellation points using some criterion, such a minimum Euclidean distance, provides a reduced set of constellation points from the transmitter constellation. The transmitted signal is then obtained by performing an ML-detection process on the reduced set of constellation points. In one embodiment of the present invention, a ZF method is employed to provide a decoding complexity that is equal to that of a ZF detector added with the complexity of a 4 QAM ML. Typically, a receiver with multiple receiver antennas, for instance as part of part of a mobile device, a personal digital assistant and a laptop, is configured to detect the transmitted signal from the transmitter constellation.

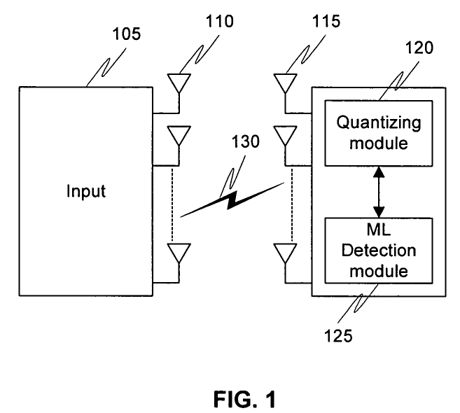

FIG. 1, shows multiple transmit antennas 110 for receiving an input 105, generally in the form of bits that are mapped to a signal constellation, according to an embodiment. Transmit antennas 110 transmit signals chosen from the signal constellation, which is then received at the multiple receiver antennas 115.

In a typical wireless communication system a modulated signal vector ‘S’ is transmitted through a channel having a corresponding channel matrix ‘H’ and is received at the receiver antennas as a vector ‘Y’. The transmitted modulated signal ‘S’ is affected due to the presence of obstacles and noise ‘N’ in the channel, and therefore the received signal vector ‘Y’ is different from the original modulated signal ‘S’ and can be represented by:
Y=H*S+N
where * denotes matrix multiplication.

For example, in a single transmit and single receive antenna wireless system, where the channel 130 is a multipath channel with the delay spread L, the received symbol at anytime is a function of L successively transmitted signals and is given by the matrix equation:

$$[ \begin{matrix}{y}_{k + L - 1} \\ {y}_{k + L - 2} \\ {y}_{k + L - 3} \\ ⋮ \\ {y}_{k}\end{matrix} ] = [ \begin{matrix}{h}_{1} & {h}_{2} & {h}_{3} & ⋯ & ⋯ & {h}_{L} \\ 0 & {h}_{1} & {h}_{2} & ⋯ & ⋯ & {h}_{L - 1} \\ 0 & 0 & {h}_{1} & ⋯ & ⋯ & {h}_{L - 2} \\ 0 & 0 & 0 & ⋯ & ⋯ & ⋮ \\ ⋮ & ⋮ & ⋮ & ⋮ & ⋮ & ⋮ \\ 0 & 0 & 0 & ⋯ & 0 & {h}_{1}\end{matrix} ] [ \begin{matrix}{s}_{k + L - 1} \\ {s}_{k + L - 2} \\ {s}_{k + L - 3} \\ ⋮ \\ {s}_{k}\end{matrix} ] [ \begin{matrix}{n}_{k + L - 1} \\ {n}_{k + L - 2} \\ {n}_{k + L - 3} \\ ⋮ \\ {n}_{k}\end{matrix} ]$$

where,
yₖ: treceived signal point at the k^{th} time instant,
sₖ: transmitted signal point at the k^{th} time instant,
nₖ: additive noise value at the k^{th} time instant,
hᵢ: channel tap coefficients of the delay line model of the multi-path channel where i=1,2, . . .
   The receiver needs to estimate the signal points sᵢ, i=k,k+1, . . . , k+L−1, from the received points yᵢ, i=k,k+1, . . . , k+L−1.

For MIMO channels 130 with multiple transmit antennas and multiple receive antennas where the received symbol at a particular receive antenna at anytime is a linear combination of symbols from all transmit antennas, the received signal vector is given by the following matrix equation.

$$[ \begin{matrix}{y}_{1} \\ {y}_{2} \\ {y}_{3} \\ ⋮ \\ {y}_{{M}_{r}}\end{matrix} ] = [ \begin{matrix}{h}_{11} & {h}_{12} & {h}_{13} & ⋯ & ⋯ & {h}_{1 {M}_{t}} \\ {h}_{21} & {h}_{22} & {h}_{23} & ⋯ & ⋯ & {h}_{2 {M}_{t}} \\ {h}_{31} & {h}_{32} & {h}_{33} & ⋯ & ⋯ & {h}_{3 {M}_{t}} \\ ⋮ & ⋮ & ⋮ & ⋮ & ⋮ & ⋮ \\ {h}_{{M}_{r} 1} & {h}_{{M}_{r} 2} & ⋯ & ⋯ & ⋯ & {h}_{{M}_{r} , {M}_{t}}\end{matrix} ] [ \begin{matrix}{s}_{1} \\ {s}_{2} \\ {s}_{3} \\ ⋮ \\ {s}_{{M}_{t}}\end{matrix} ] + [ \begin{matrix}{n}_{1} \\ {n}_{2} \\ {n}_{3} \\ ⋮ \\ {n}_{{M}_{r}}\end{matrix} ]$$

where,
Mₜ: the number of transmit antennas;
Mᵣ: the number of the receive antennas;
yᵢ: the received signal at the i^{th} receive antenna where i=1,2,3, . . . , Mᵣ;
sⱼ: the transmitted signal from the j^{th} transmit antenna where j=1,2,3, . . . , Mₜ;
hᵢⱼ: the path gain of the path from the j^{th} transmit antenna to the i^{th} receive antenna.
   In this case also, as in the case of single transmit and single receive antenna multipath communication system, the receiver needs to estimate the transmitted signal vector from the received vector.

Under an embodiment of the invention, a detection method isolates a constellation point of the transmitter constellation by processing an altered signal. The altered signal is a detected signal and comprises a product of the received signal matrix (Y) and a transformation matrix corresponding to the transmission channel. For example, in the case of a ZF detection scheme, the altered signal comprises a product of the received signal matrix (Y) and an inverse of the channel matrix (H⁻¹). The Zero-Forcing (ZF) detection technique is one of the most straightforward approaches used conventionally for detecting signals at the receiver antennas, and can be employed in cases where the complexity of the detection increases only linearly with the size of the constellation, multiplied by the number of transmitted symbols that were entangled due to the obstacles and noise present in the MIMO or multipath channels. For an isolated constellation point, for example, a single point of the constellation obtained by performing a ZF detection only serves to provide a rough estimate of the transmitted signal.

A Quantizing module 120 quantizes the altered signal to obtain a reduced constellation from the transmitter constellation. The Quantizing module 120 can be included within a receiver or a system coupled to the receiver antennas. The reduced constellation is a subset of constellation points from the transmitter constellation. Those skilled in the art shall appreciate that quantizing is a method generally known in the art and can be used to obtain the reduced constellation from the transmitter constellation using mathematical operations performed on the altered signal. However, other mathematical operations that strive to provide a similar reduced constellation using other operations can also be used and all such mathematical operations are within the scope of the present invention.

In one embodiment, an ML detection module 125 coupled to quantizing module 120 is configured to perform an ML detection operation on the reduced constellation. In general, performing ML detection on the reduced constellation substantially reduces the complexity of the detection scheme as opposed to performing ML detection on the complete transmitter constellation.

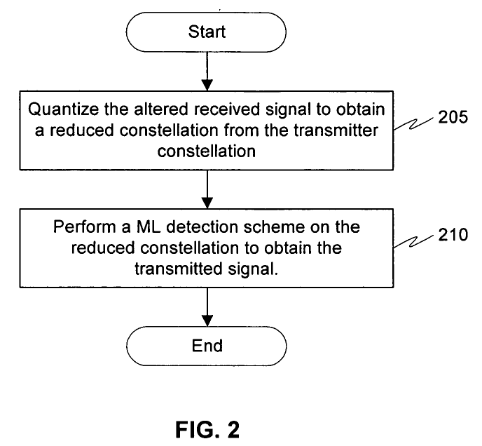

FIG. 2 is a flow diagram depicting the steps of detecting a transmitted signal from a transmitter constellation, under an embodiment. The altered signal comprises a product of a received signal matrix corresponding to a transmitted signal and a transformation matrix corresponding to a transmission channel. The transformation, for example, is the inverse of the channel matrix, H⁻¹, in the case of ZF detection and H^{H}[HH^{H}+(I/SNR)Mₜ] ⁻¹ in the case of MMSE detection, where H^{H} denotes the conjugate transpose of the matrix H, SNR stands for signal-to-noise ratio per receive antenna and Mₜ denotes the number of transmit antennas.

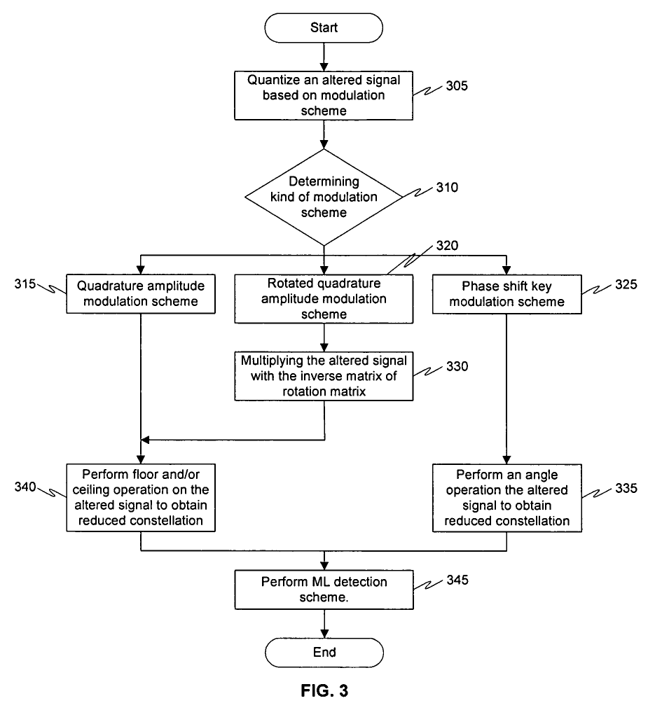

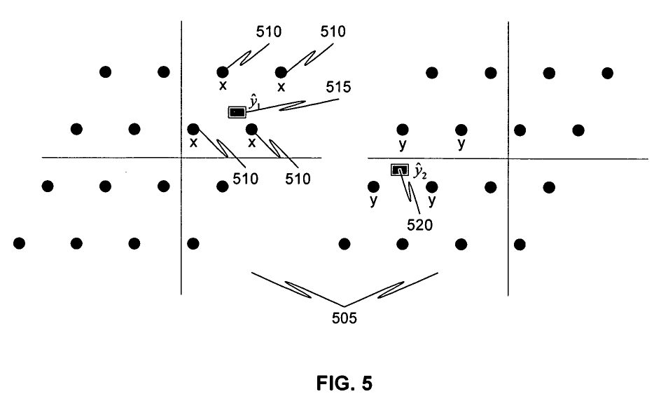

Under one embodiment of the invention, the altered signal is quantized to obtain a reduced constellation from the transmitter constellation based on a predetermined procedure, step 205. The altered signal can be obtained using, for instance a zero forcing (ZF) detection scheme or a minimum mean square error (MMSE) detection scheme or any such scheme that provides an approximate location of the received signal. For example, a ZF detection technique when applied to the received signal vector Y generates an altered received vector ŝᵢ. This altered signal is quantized to obtain a reduced set of structured constellation depending on the kind of modulation scheme. Some of the modulation schemes used can be a regular Quadrature Amplitude Modulation (QAM) scheme, a rotated Quadrature Amplitude Modulation scheme, a Phase Shift Keying modulation scheme or any such structured modulation scheme such as the lattice constellation modulation as shown in FIG. 5. The quantizing of the altered signal for some of the modulation schemes is explained using FIG. 3.

An ML detection follows on the reduced constellation to obtain the transmitted signal, step 210. Performing ML detection without the quantization, step 205, would increase the complexity exponentially as the size of the constellation increases. Hence, executing an initial detection scheme to obtain a reduced constellation and thereafter performing ML detection provides lesser complexity.

FIG. 3 is a flow diagram depicting the steps of quantizing an altered signal based on a modulation scheme in accordance with an embodiment of the invention. As stated previously, the altered signal is quantized to obtain a reduced constellation based on the modulation, step 305. Those skilled in the art shall appreciate that there are several modulation methods available and all structured modulations are within the scope of the present invention. While quantizing, the modulation method is determined, step 310. In a regular Quadrature Amplitude Modulation (QAM) modulation step 315, a floor or ceiling operation is performed on the altered signal. For example, in a 16 QAM constellation where every constellation point is represented as a two tuple comprising a real and imaginary value, performing a floor and ceiling operation on the altered received signal yields four signal points on the transmitted constellation for each coordiate position of the received vector, step 340. The reduced constellation is a cartesian product of the sets of the four nearest constellation points S(ŝᵢ, ŷᵢ) in each coordinate position i. Similarly, in a rotated QAM scheme, step 320, the altered signal ŝᵢ, being a product of the transmitted signal matrix and a transformation matrix, is multiplied with the inverse of the rotation matrix to obtain a rotated altered signal, step 330. The rotation matrix corresponds to the rotated QAM. The rotated QAM can now be treated as a regular QAM constellation and quantized to obtain the reduce constellation. If the modulation technique employed is symmetric Phase Shift Keying (PSK), step 325, quantizing Y to the nearest angles to ŝᵢ on both positive and negative sides in each coordinate axes, step 335, and then taking the Cartesian product of resultant subsets in each complex coordinate yields a set of nearest points S(ŝᵢ,ŷᵢ). The set of nearest points S(ŝᵢ,ŷᵢ) represents the reduced constellation for the coordinate position i. Other structured modulation techniques known in the art can also be employed and all such structured modulation techniques can be quantized to obtain the desired reduced constellation. The size of the reduced constellation can also vary to improve accuracy, for example additional points near the altered signal can be obtained by quantizing the altered signal and included in the reduced signal set.

An ML detection method is then executed on the reduced constellation to obtain the transmitted signal, step 345. The ML detector evaluates an Euclidian distance between the altered signal and the Cartesian product of the set of reduced constellation points obtained after quantization, namely S(ŝᵢ, ŷᵢ). Typically, an ML demodulator's complexity is exponential in the size of the constellation used, the exponent being the number of transmitted symbols that got entangled. In the embodiment of the invention, a ZF detection technique (employed to obtain the nearest constellation point to the altered signal) is used to provide an initial symbol estimation. The symbol estimation is then quantized to obtain a reduced constellation, which reduces the complexity of ML demodulation. The reduced constellation enables the ML detector to search only those constellation points that are in close proximity to the ZF detected point. The embodiment of the present invention, wherein the altered signal is obtained by ZF method for a QAM constellation, provides a decoding complexity that is equal to that of a ZF detector added with the complexity of a 4 QAM ML.

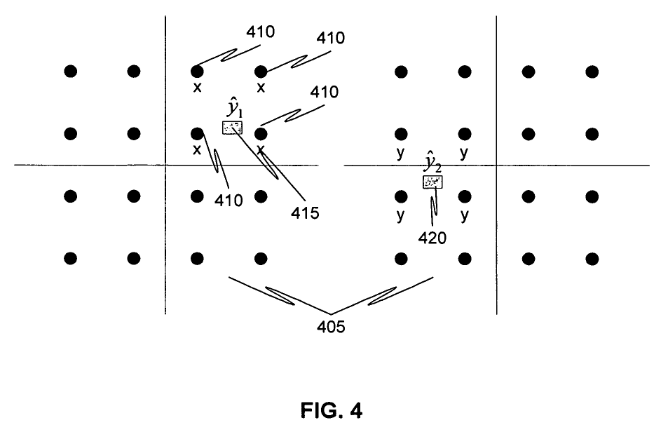

FIG. 4 and FIG. 5 show two graphical representations of the transmitted signal constellation 405, 505 corresponding to two transmit antennas. FIG. 4 represents a regular QAM constellation while FIG. 5 represents a typical lattice constellation. In conventional systems, a typical ML detection scheme would need to traverse all constellation points. Based on the order of modulation, the number of constellation points increases exponentially, which in turn increases the complexity of ML detection. For example, a 4QAM modulation order would involve the traversal of 16 constellation points.

In accordance with the embodiment of the invention, a detection method such as ZF detection for an altered signal 415 or 515 provides four nearest constellation points 410 or 510 corresponding to altered signal 415 and altered signal 515 respectively, constituting the reduced constellation. For example, quantizing altered signal 415 produces signal points 410 on the QAM constellation shown in FIG. 4, and quantizing altered signal 515 produces signal points 510 as shown in the lattice constellation in FIG. 5. Correspondingly, the signal transmitted from the second transmitter antenna is received as altered signal 420 or 520. The altered signal 420 or 520 are quantized to obtain signal points “y” on the signal constellation. Quantizing involves performing a mathematical operation, for example, a floor and a ceiling operation to obtain four constellation points marked “x”, “y”, constituting the reduced constellation, nearest to the altered signal 415, 420, 515, or 520. Those skilled in the art shall appreciate that additional signal points on the constellation can also be obtained to improve accuracy. Carrying out a restricted ML detection on the Cartesian product of the set of reduced constellation points labeled ‘x’ in the first transmitter constellation and the set of reduced constellation points labeled ‘y’ for the second transmitter constellation corresponding to the second transmitter antenna gives the actual transmitted symbol pair representing the signal, namely (ŝ₁, ŝ₂).

What is claimed is:

1. A method of detecting a transmitted signal from a transmitter constellation, the method comprising:
processing the transmitted signal to produce an altered signal;
quantizing the altered signal to obtain a reduced constellation from the transmitter constellation based on a predetermined procedure; and
performing a maximum-likelihood detection scheme on the reduced constellation to obtain the transmitted signal.

2. The method of claim 1, where the altered signal is obtained using at least one of a zero forcing (ZF) detection scheme and a minimum mean square error (MMSE) detection scheme.

3. The method of claim 1, wherein the altered signal comprises a product of a received signal matrix corresponding to the transmitted signal and a transformation matrix based on a transmission channel.

4. The method of claim 3, wherein the predetermined procedure is based on a modulation scheme.

5. The method of claim 4, wherein the predetermined procedure comprises:
performing at least one of a floor and ceiling operation on the altered signal to obtain the reduced constellation for a QAM modulation scheme.

6. The method of claim 4, wherein the predetermined procedure comprises:
performing an angle operation on the altered signal to obtain the reduced constellation for a PSK modulation scheme, the angle operation computing at least one nearest angle to the altered signal.

7. The method of claim 4, wherein the predetermined procedure comprises:
multiplying the altered signal with a transformation of a rotation matrix for a rotated QAM scheme to obtain a rotated altered signal, the rotation matrix corresponding to a rotated QAM; and
performing at least one of a floor and ceiling operation on the rotated altered signal to obtain the reduced constellation for the rotated QAM scheme.

8. The method of claim 4, wherein the modulation scheme comprises at least one of a quadrature amplitude modulation (QAM) scheme, rotated QAM scheme, phase-shift keying (PSK) scheme and a lattice constellation modulation scheme.

9. A receiver to detect a transmitted signal from a transmitter constellation, the receiver comprising:
a processor;
a memory operatively coupled to the processor and configured to store instructions that cause the processor to:
process the transmitted signal to produce an altered signal;
quantize the altered signal to obtain a reduced constellation from the transmitter constellation based on a predetermined procedure; and
perform a maximum-likelihood detection scheme on the reduced constellation to obtain the transmitted signal.

10. The receiver of claim 9, where the altered signal is obtained using at least one of a zero forcing (ZF) detection scheme and a minimum mean square error (MMSE) detection scheme.

11. The receiver of claim 9, wherein the altered signal comprises a product of a received signal matrix corresponding to the transmitted signal and a transformation matrix based on a transmission channel.

12. The receiver of claim 11, wherein the predetermined procedure is based on a modulation scheme.

13. The receiver of claim 12, wherein the modulation scheme comprises at least one of a quadrature amplitude modulation (QAM) scheme, rotated QAM scheme, phase-shift key (PSK) scheme.

14. The receiver of claim 9 is a part of at least one of a mobile device, a personal digital assistant and a laptop.

15. A system to detect a transmitted signal from a transmitter constellation, the system comprising:
a processing module for transforming the transmitted signal to produce an altered signal;
a quantizing module for quantizing the altered signal to obtain a reduced constellation from the transmitter constellation based on a predetermined procedure; and
an ML-detection module for performing a maximum-likelihood detection scheme on the reduced constellation to obtain the transmitted signal.

16. The system of claim 15, wherein the predetermined procedure is based on a modulation scheme.

17. The system of claim 16, wherein the quantizing module is configured to perform at least one of a floor and ceiling operation on the altered signal to obtain the reduced constellation for a QAM modulation scheme.

18. The system of claim 16, wherein the quantizing module is configured to perform an angle operation on the altered signal to obtain the reduced constellation for a PSK modulation scheme, the angle operation computing at least one nearest angle to the altered signal.

19. The system of claim 16, wherein the quantizing module is configured to multiply the altered signal with a transformation of a rotation matrix for a rotated QAM scheme to obtain a rotated altered signal, the rotation matrix corresponding to a rotated QAM and performing at least one of a floor and ceiling operation on the rotated altered signal to obtain the reduced constellation for the rotated QAM scheme.

20. The system of claim 16, wherein the modulation scheme comprises at least one of a quadrature amplitude modulation (QAM) scheme, rotated QAM scheme, phase-shift key (PSK) scheme.

21. The system of claim 15, wherein the system is part of a receiver system.
